(19) United States
(12) Patent Application Publication
(10) Pub. No.: US 2013/0054566 A1
(43) Pub. Date: Feb. 28, 2013

(54) ACCELERATION OF RANKING ALGORITHMS USING A GRAPHICS PROCESSING UNIT

(71) Applicants: NINGYI XU, Beijing (CN); Allan Wu, Beijing (CN); Jin Li, Sammamish, WA (US); Yu Wang, Beijing (CN); Chunshui Zhao, Beijing (CN); Feng-Hsiung Hsu, Cupertino, CA (US)

(72) Inventors: NINGYI XU, Beijing (CN); Allan Wu, Beijing (CN); Jin Li, Sammamish, WA (US); Yu Wang, Beijing (CN); Chunshui Zhao, Beijing (CN); Feng-Hsiung Hsu, Cupertino, CA (US)

(73) Assignee: MICROSOFT CORPORATION, REDMOND, WA (US)

(21) Appl. No.: 13/222,396

(22) Filed: Aug. 31, 2011

(51) Int. Cl. G06F 17/30

(52) U.S. Cl. 707/713; 707/E17.131; 707/E17.069

(57) ABSTRACT

Methods, computer systems, and computer-readable media for accelerating a learning-to-rank algorithm using a central processing unit (CPU) and a graphics processing unit (GPU) are provided. The GPU processes document pairs created by the CPU in parallel to generate a lambda-gradient value and a weight for each document. The CPU builds a regression tree for the documents. The GPU is utilized to accelerate this process by constructing histograms of feature values, wherein the address of bins collecting the same feature value are shifted during the construction of the histogram. The output of the regression tree is a score for each document which is used to rank or order the document on a search engine results page.

### BACKGROUND

For search engines, the ability to deliver relevant search results in response to a search query is vitally important. The search results are ranked or ordered according to a ranking model. In turn, learning-to-rank algorithms are used to train the ranking models. Learning-to-rank algorithms usually run intensive computations over very large training data sets iteratively. Traditionally, central processing units have processed all aspects of the learning-to-rank algorithms, but they are ill-equipped to handle the intensive computations and the ever-increasing size of the training data sets. The result is that it takes longer and longer for learning-to-rank algorithms to generate efficient ranking models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention are directed to methods, computer systems, and computer storage media for accelerating learning-to-rank algorithms using both a central processing unit (CPU) and a graphics processing unit (GPU). The GPU is essentially a special purpose processor, optimized to perform certain types of parallel computations and is ideally suited to execute certain computations on the large training data sets associated with learning-to-rank algorithms. This helps to accelerate the time it takes for a learning-to-rank algorithm to produce a ranking model. More specifically, embodiments of the present invention accelerate the most time-consuming processes of the learning-to-rank algorithms, lambda-gradient value calculation and histogram construction, by utilizing a GPU instead of a CPU to perform these processes.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary computing system environment suitable for accelerating a learning-to-rank algorithm;

FIG. 3 depicts an exemplary regression tree structure in accordance with an embodiment of the present invention;

FIG. 4 depicts an exemplary method of constructing a complete histogram from partial histograms;

FIG. 5 depicts an exemplary method of building a complete histogram from partial histograms suitable to implements embodiments of the present invention;

FIG. 6 depicts a flow diagram illustrating a method for accelerating a learning-to-rank algorithm by using a central processing unit (CPU) and a graphics processing unit (GPU) suitable to implement embodiments of the present invention;

FIG. 7 depicts a flow diagram illustrating a method of using a CPU and a GPU for generating lambda-gradient values for a set of documents suitable to implement embodiments of the present invention;

FIG. 8 depicts a flow diagram illustrating a method of using a CPU and a GPU for building a regression tree in a learning-to-rank algorithm suitable to implement embodiments of the present invention; and

FIG. 9 depicts a flow diagram illustrating a method of building a complete histogram from partial histograms suitable to implement embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, computer systems, and computer storage media for accelerating learning-to-rank algorithms using both a central processing unit (CPU) and a graphics processing unit (GPU). The GPU is essentially a special purpose processor, optimized to perform certain types of parallel computations and is ideally suited to execute certain computations on the large training data sets associated with learning-to-rank algorithms. This helps to accelerate the time it takes for a learning-to-rank algorithm to produce a ranking model. More specifically, embodiments of the present invention accelerate the most time-consuming processes of the learning-to-rank algorithms, lambda-gradient value calculation and histogram construction, by utilizing a GPU instead of a CPU to perform these processes.

Accordingly, in one embodiment, the present invention is directed toward a computer-implemented system for accelerating a learning-to-rank algorithm using a CPU and a GPU. The CPU is operable to create pairs of documents received in response to a search query. Each document has an associated label and an associated score. The CPU pairs the documents by pairing a first document with one or more second documents. The first document has a different label than the one or more second documents. The GPU is operable to receive the pairs of documents along with their associated labels and scores and process the document pairs in parallel to generate a lambda-gradient value and a weight for each of the documents.

In another embodiment, the present invention is directed toward a computer-implemented system for parallelizing regression tree building using a CPU and a GPU. The CPU is operable to assign documents received in response to a search query to a parent node; each of the documents has an associated lambda-gradient value. The CPU determines a feature that characterizes the documents in the parent node. The GPU calculates information gains for the feature by using histogram construction, and the CPU determines an optimal threshold for splitting the documents in the parent node into a left child node and a right child node. The optimal threshold is dependent upon the information gains for the feature. As well, the optimal threshold comprises the highest cumulative lambda-gradient value for documents in the left child node and the highest cumulative lambda-gradient value for documents in the right child node. The CPU splits the documents based on the optimal threshold and determines a score for each document.

In yet another embodiment, the present invention is directed toward one or more compute storage media, executable by a computing device, for facilitating a method of a GPU building a complete histogram using partial histograms. The GPU has multiple threads of execution running in parallel. Each thread of execution builds a subhistogram, and each thread of execution has multiple addresses corresponding to bins useable for collecting feature values associated with a set of documents. The address of a bin that collects the same feature value in each subhistogram is different amongst the different threads of execution.

Continuing, a first feature value of a first document is identified and is mapped to a first thread of execution building a subhistogram. The first feature value is collected in a bin at a first address of the subhistogram. A second feature value of a second document is identified and is mapped to a second thread of execution building another subhistogram. The second feature value is collected in a bin at a second address of the subhistogram. The first address is different from the second address. The complete histogram is built by mapping feature values collected in bins with the same address in different threads of execution to bins in the complete histogram. Each mapped feature value is different from each other, and each feature value is mapped to a different bin of the complete histogram.

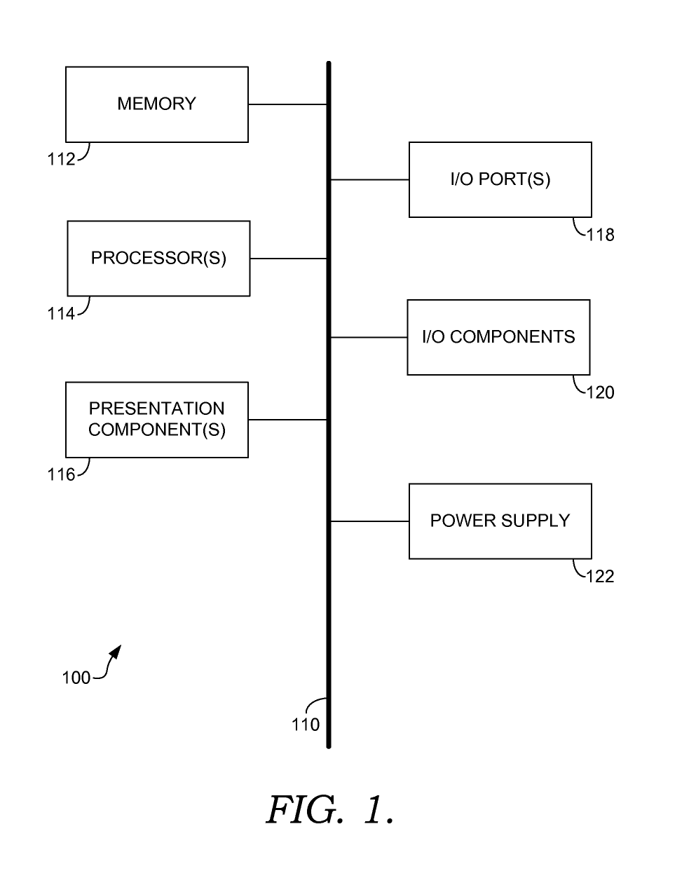

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a set of one or more processes distributed on one or more computers, one or more stand-alone storage devices, a set of one or more other computing or storage devices, a combination of one or more of the above, and the like.

As a preface to the more detailed discussions below, some general information is provided regarding search engines, ranking models, learning-to-rank algorithms, the capabilities of a GPU compared to a CPU, and how a GPU is generally structured. The usefulness of a search engine depends on the relevance of the documents it returns in response to a search query. The term documents as used throughout this specification is meant to refer to a set of search results returned in response to a search query and includes, without limitation, any type of content including uniform resource locators (URLs), images, information, and other types of files. The search engine may employ a ranking model to rank or order the documents by assigning the documents a score. A document with a higher score will be ranked higher (and deemed more relevant) than a document with a lower score.

Learning-to-rank algorithms are used to train the ranking models. There are many examples of learning-to-rank algorithms including, for example, Microsoft FastRank™. At a high level, these learning-to-rank algorithms learn by processing training data sets (ground truth samples). The training data sets consist of queries and documents that are returned in response to the queries. Human assessors check the documents for some of the queries and determine a relevance of each document returned in response to the query. For example, a search query may be the term “White House,” and the set of documents returned in response to the query may include “www.whitehouse.org,” “www.whitehouse.us.org,” and “www.house.com.” A human assessor may label “www.whitehouse.org” as a perfect match, “www.whitehouse.us.org” as a good match, and “www.house.com” as a bad match. The label indicates a quality of a relationship of the document to the search query. These human-labeled documents are then used as the training data set for the learning-to-rank algorithm to produce a ranking model.

The learning-to-rank algorithm may, in one aspect, use a pairwise approach to generate a ranking model. In simple terms, the learning-to-rank algorithm learns a binary classifier which can tell which document is better in a given pair of documents in the training data set. The given pair of documents consists of two documents with different human-applied labels. For example, a “perfect match” document may be paired with a “good match” document, or a “bad match” document. Once the learning-to-rank algorithm produces a ranking model, the ranking model's purpose is to rank new, unseen documents in a way which is similar to the rankings in the training data set.

With respect to GPUs, the multi-core architecture of a GPU is optimized for floating-point computations involving very large data sets. By contrast, dozens of multi-core CPUs may be required to achieve the same computation power as the GPU. Additionally, GPUs can achieve higher memory bandwidth than CPUs partially because of their massively parallel architecture and their memory hierarchy.

GPUs have hundreds of computing cores or processors operating in parallel. These cores are organized into units of multiprocessors. Each multiprocessor has up to eight cores operating in parallel. Each core is associated with a thread of execution (thread) where a thread is the smallest unit of processing that can be scheduled by an operating system. The thread can be executed in parallel with other threads by the multiprocessor. In turn, a thread block may consist of a group of threads. The thread block may occupy a multiprocessor or several multiprocessors. The threads of a multiprocessor share a block of local memory (localized shared memory).

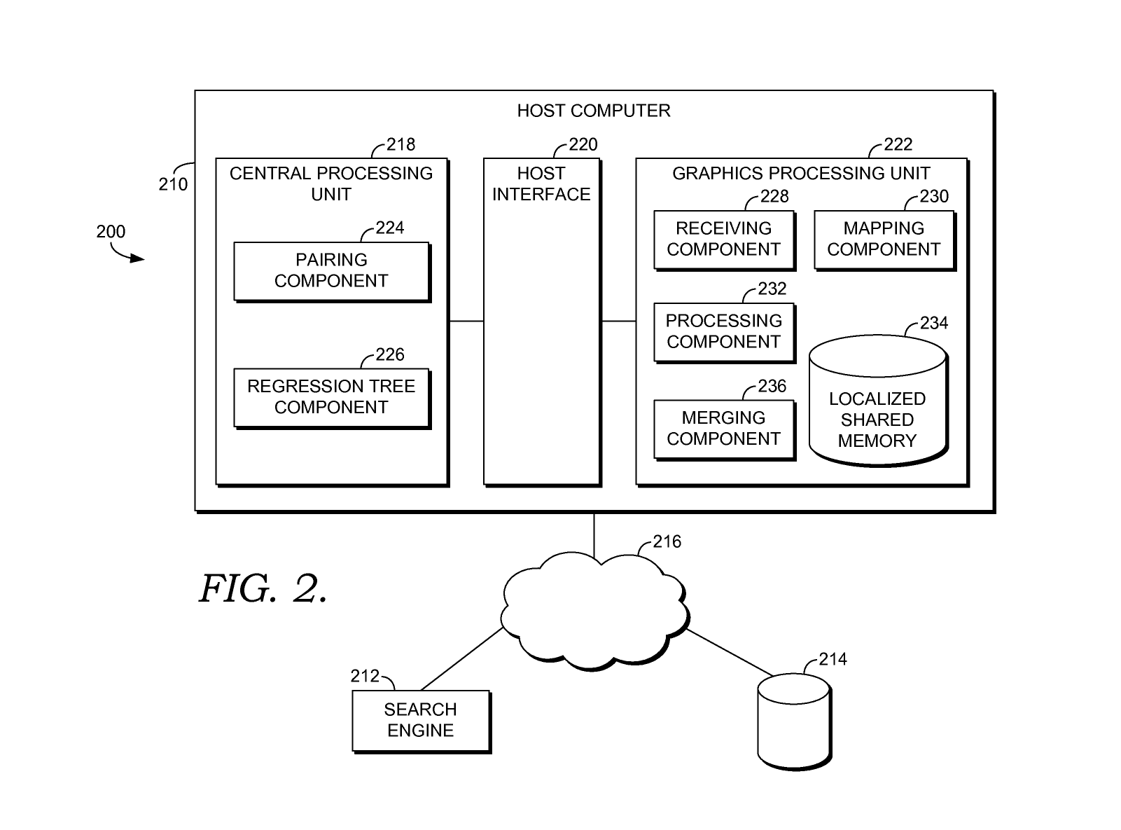

With this as a background and turning to FIG. 2, an exemplary computing environment 200 is depicted for use in accelerating a learning-to-rank algorithm. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a host computer 210, a data store 214, and a search engine 212 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into the operating system of the host computer 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the host computer 210 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The search engine 212 may be any Web-based search engine. The search engine 212 is capable of receiving a search query, accessing, for example, the data store 214, and returning a set of documents in response to the search query to the host computer 210 via the network 216. The search engine 212 is also capable of applying a ranking model to the set of documents to produce a ranked order for the documents.

The data store 214 is configured to store information for use by, for example, the search engine 212. For instance, upon receiving a search query, the search engine 212 may access the data store 214 for information related to the search query. In embodiments, the data store 214 is configured to be searchable for one or more of the items of information stored in association therewith. The information stored in association with the data store 214 may be configurable and may include any information relevant to Internet search engines. The content and volume of such information are not intended to limit the scope of embodiments of the present invention in any way. Further, though illustrated as a single, independent component, the data store 214 may, in fact, be a plurality of storage devices, for instance, a database cluster, portions of which may reside on the search engine 212, the host computer 210, and/or any combination thereof.

The host computer shown in FIG. 2 may be any type of computing device, such as, for example, computing device 100 described above with reference to FIG. 1. By way of example only and not limitation, the host computer 210 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

Components of the host computer 210 may include, without limitation, a CPU 218, a GPU 222, internal system memory (not shown), localized shared memory 234, and a suitable host interface 220 for coupling various system components, including one or more data stores for storing information (e.g., files and metadata associated therewith). The host computer 210 typically includes, or has access to, a variety of computer-readable media.

The computing system environment 200 is merely exemplary. While the host computer 210 is illustrated as a single unit, it will be appreciated that the host computer 210 is scalable. For example, the host computer 210 may in actuality include a plurality of computing devices in communication with one another. Moreover, the data store 214, or portions thereof, may be included within, for instance, the host computer 210 as a computer-storage medium. The single unit depictions are meant for clarity, not to limit the scope of embodiments in any form.

As shown in FIG. 2, the host computer 210 comprises a CPU 218. The CPU 218, in turn, comprises a pairing component 224 and a regression tree component 226. The host computer 210 also comprises a GPU 222. The GPU 222 comprises a receiving component 228, a mapping component 230, a processing component 232, localized shared memory 234, and a merging component 236. In some embodiments, one or more of the components 224, 226, 228, 230, 232, and 236 may be implemented as stand-alone applications. In other embodiments, one or more of the components 224, 226, 228, 230, 232, and 236 may be integrated directly into the operating system of a computing device such as the computing device 100 of FIG. 1. It will be understood by those of ordinary skill in the art that the components 224, 226, 228, 230, 232, and 236 illustrated in FIG. 2 are exemplary in nature and in number and should not be construed as limiting. Any number of components may be employed to achieve the desired functionality within the scope of embodiments hereof.

Further, although components 224, 226, 228, 230, 232, and 236 are shown as a series of components, they may be implemented in a number of ways that are well known in the art. For example, they may be implemented as a system on one or more chips, one or more applications implemented on one or more chips, and/or one or more applications residing in memory and executable by the CPU 218 and the GPU 22. Any and all such variations are within the scope of embodiments of the present invention.

In one embodiment of the invention, the CPU 218 and the GPU 222 may work sequentially and iteratively with each other. For example, the CPU 218 may receive an input and generate an output. The output may then be an input for the GPU 222 which, in turn, generates a new output which is useable by the CPU 218. In another embodiment of the invention, the CPU 218 and the GPU 222 may work in parallel with each other, each processing data at the same time. Any and all such variations are within the scope of embodiments of the present invention.

In another embodiment of the invention, the host computer 210 may comprise the CPU 218, the GPU 222, and one or more additional GPUs. With respect to this embodiment, the host computer 210 would include a parallelized algorithm designed to integrate the computing power of the multiple GPUs.

The pairing component 224 of the CPU 218 is configured to create pairs of documents received by the CPU 218. In one embodiment, the documents received by the CPU 218 may be received (via the network 216) from the search engine 212 in response to a search query. The documents received in response to the search query may be limited in number. For example, the document set may be limited to 100-150 documents. Human-applied labels (label(s)) may be applied to the documents as outlined above to generate a training data set. As mentioned, the label indicates a quality of a relationship of the document to the search query and may include such labels as perfect, good, bad, and the like.

In another embodiment of the invention, the documents received by the CPU 218 may be received from the GPU 222 via the host interface 220. A document received in this manner may undergo further processing by the CPU 218 to generate a score for the document. The further processing by the CPU 218 may include regression tree construction; a process that will be explained in greater depth below. Again, as mentioned above, the score of the document determines a ranking order for the document on a search engine results page. The documents received by the CPU 218 from the GPU 222 may also have associated labels.

The pairing component 224 creates pairs of documents by pairing a first document with one or more second documents. The first document has a different label than the one or more second documents. For example, document 1 may be labeled as perfect, document 2 labeled as good, and document 3 labeled as bad. The pairing component may create document pairs (1, 2), (1, 3), and (2, 3).

The document pairs created by the pairing component 224 may be received by the receiving component 228 of the GPU 222 via the host interface 220. The receiving component 228 is configured to receive the document pairs along with their associated labels and scores.

The processing component 232 of the GPU 222 is configured to process the document pairs received by the receiving component 228. The document pairs are processed in parallel to generate a lambda-gradient value and a weight for each document. The processing component 232 of the GPU 222 is ideally suited for this type of processing because of the spatial complexity and the calculation complexity of the input data (i.e., the document pairs). The spatial complexity of the input data is proportional to the number of documents, N, processed (i.e., the number of documents received in response to the search query). The calculation complexity of the input data is proportional to the number of document pairs in the search query, N².

The structure of the processing component 232 of the GPU 222 was explained above but will be repeated here for purposes of emphasis. The processing component 232 contains many multiprocessors acting in parallel. Each multiprocessor has up to eight processors or cores running in parallel; each core has an associated thread of execution (thread). As well, a thread block may consist of a group of threads. The thread block may occupy a multiprocessor or several multiprocessors. The threads of a multiprocessor share a block of local memory (i.e., localized shared memory 234).

In one embodiment of the invention, each thread block occupies one multiprocessor and processes one query of documents (the document set received in response to the search query). In turn, each thread of the multiprocessor calculates the lambda-gradient value and the weight of one or more documents. For example, thread 0 may process one pair of documents to generate a lambda-gradient value and a weight for one or both documents in the pair, while thread 1 may process another pair of documents to generate a lambda-gradient value and a weight for one or both documents in the pair. Because a first document may be paired with one or more second documents, two different threads may process the first document. Further, because the threads in the thread block share localized shared memory 234, data associated with each document may be shared amongst the different threads thus providing good locality of reference. This helps in performance optimization of the GPU 222.

As mentioned, the processing component 232 processes the document pairs to generate a lambda-gradient value and a weight for each document. A lambda-gradient value is a temporary value that is useable by the GPU 222 when constructing a histogram; this process will be explained in greater depth below. The weight of a document is the derivative of the lambda-gradient value for the document.

The documents, with their associated lambda-gradient values and their weights, are received by the regression tree component 226 of the CPU 218 (via the host interface 220). The regression tree component 226 is configured to build a regression tree for the documents. The output of the regression tree is a new score for each document in the set of documents. In essence, the regression tree becomes the new ranking model that is useable by, for example, the search engine 212 to rank or order a set of documents on a search engine results page based on document scores.

Regression tree building is a time-consuming process for the CPU 218. The mapping component 230 of the GPU 222 is utilized to accelerate the most time-consuming portion of regression tree building—histogram construction. At a high level, a regression tree is formed by a collection of rules based on variables in the training data set. The rules are selected to obtain the best split of documents into nodes in order to differentiate observations based upon a dependent variable. Once a rule is selected and the documents are split into two nodes, the same process is applied to the new sets of documents. The splitting of the documents ends when no further information gains can be made or when a user-specified limit is reached (e.g, a user-specified limit may be that a certain number of documents must be present in a node).

Turning back to the regression tree component 226 of FIG. 2, the regression tree component 226 receives the documents with their associated lambda-gradient values and weights from the processing component 232 of the GPU 222 via the host interface 220. The regression tree component 226 assigns the documents to a parent node and determines a feature that characterizes all the documents in the parent node. A feature describes a certain characteristic of a document. For example, a feature may the number of words in a document's URL. Each document can be described by many features, and each feature comprises a set of feature values. Using the example of the number of words in the URL, if there are two words in a document's URL, the feature value of the document is “2,” if there are three words in a document's URL, the feature value of the document is “3,” and so on.

Continuing, the regression tree component 226 determines an optimal threshold for splitting the documents into a left child node and a right child node. The optimal threshold for splitting the documents is the split that provides the most information gains for the selected feature. Since the feature values are discrete, the easiest and fastest way to find the threshold that produces the most information gains is by histogram construction. In one embodiment of the invention, histogram construction is performed by the mapping component 230 of GPU 222. In simplistic terms, the GPU 222 calculates all the possible information gains for all the features at each time of the split, and the CPU 218 then selects the optimal threshold for the split.

Once the optimal threshold for splitting the documents is determined by the regression tree component 226, the regression tree component 226 splits the documents into the left child node and the right child node and generates a score for each document. Next, the regression tree component 226 determines a new feature that characterizes the documents in the left child node and a new feature that characterizes the documents in the right child node. Like above, the regression tree component 226 determines an optimal threshold for splitting the documents in the left child node into a left sub-child node and a right sub-child node based on information gains for the feature as determined by histogram construction. The same process occurs for the documents in the right child node. The regression tree component 226 splits the documents and generates a new score for each document. An end-point for the regression tree may be set by reaching a limit that requires that a certain number of documents be in a node. Alternatively, an end-point may be reached when no further information gains can be made.

The output of the regression tree component 226 is a new score for each document in the set of documents. In one embodiment of the invention, the documents and their new scores are useable by the processing component 232 of the GPU 222 to generate a new lambda-gradient value and a new weight for each document in the set of documents. The iterative process outlined above continues until the learning-to-rank algorithm produces an effective, efficient ranking model.

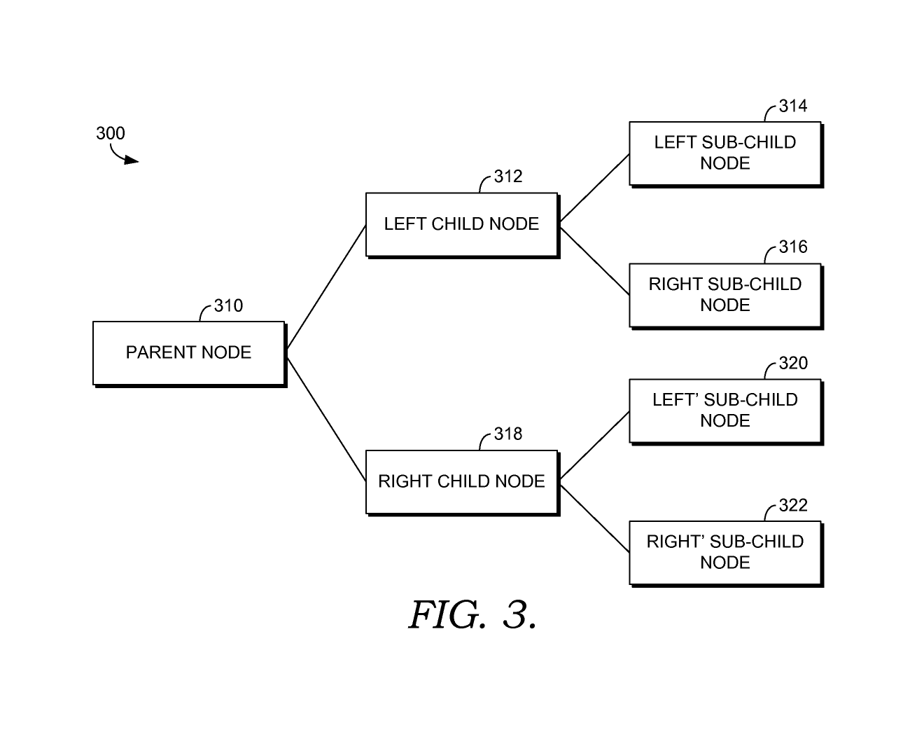

FIG. 3 depicts an exemplary regression tree structure, referenced generally by the numeral 300, in accordance with an embodiment of the present invention. The regression tree includes a parent node 310 which contains a set of documents corresponding to one search query. The regression tree component 226 determines a feature characterizes all the documents in the parent node. After information gains are calculated for the feature by histogram construction, an optimal threshold is determined by, for example, the regression tree component 226 for splitting the documents into a left child node 312 and a right child node 318. The split is optimal when it gives the highest cumulative lambda-gradient value for the documents in the left child node 312 and the highest cumulative lambda-gradient value for the documents in the right child node 318. The documents are then split into the left child node 312 and the right child node 318 based on the optimal threshold, and a score is generated for each document.

Next, the process described above is repeated for the left child node 312 and the right child node 318. For example, the regression tree component 226 determines a new feature that characterizes all the documents in the left child node 312. Information gains for that feature are calculated by, for example, the mapping component 230 of the GPU 222 by utilizing histogram construction, and an optimal threshold is determined for splitting the documents in the left child node 312 into a left sub-child node 314 and a right sub-child node 316. The documents are then split into the left sub-child node 314 and the right sub-child node 316 based on the optimal threshold, and a new score is determined for each document.

Turning back to FIG. 2, as mentioned, the most time-consuming process of regression tree building is the determination of information gains for a feature using histogram construction. The mapping component 230 of the GPU is configured to accelerate this time-consuming process by efficiently and rapidly constructing a histogram for the feature. More specifically, the mapping component 230 is configured to construct a series of partial histograms which are merged by the merging component 236 to form a complete histogram for the feature. Each bin of the complete histogram collects documents having a certain feature value. Another way to view this is that each bin of the complete histogram accumulates the lambda-gradient values of all the documents that have the same feature value. In turn, the optimal threshold determined by the regression tree component 226 for splitting the documents into two nodes, is the highest cumulative lambda-gradient value for the documents in the first node, and the highest cumulative lambda-gradient value for the documents in the second node.

The structure of the mapping component 230 of the GPU 222 is identical to that specified above for the processing component 232. With this in mind, one thread block of the mapping component 230 calculates a partial histogram for one row of documents of the set of documents having a feature while another thread block of the mapping component 230 calculates a partial histogram for another row of documents of the set of documents having the same feature. Each document in a row has an associated feature value; the feature values can be the same or different. Thus, there are multiple thread blocks operating in parallel constructing partial histograms for the set of documents. In one embodiment of the invention, each partial histogram is stored in the localized shared memory 234 associated with the thread block that constructed the partial histogram. The merging component 236 then merges the partial histograms into a complete histogram for that feature; the complete histogram may also be stored in the localized shared memory 234. The complete histogram for the feature is formed by adding the bins of the partial histograms that collect the same feature value to a bin in the complete histogram that collects that feature value.

In another embodiment of the invention, when the number of partial histograms associated with a certain feature exceeds the storage capacity of the localized shared memory 234, the memory of the CPU 218 (for example, the data store 214), can be utilized to store the partial histograms. In this case, the CPU 218 may be used to merge the partial histograms into a complete histogram for the feature.

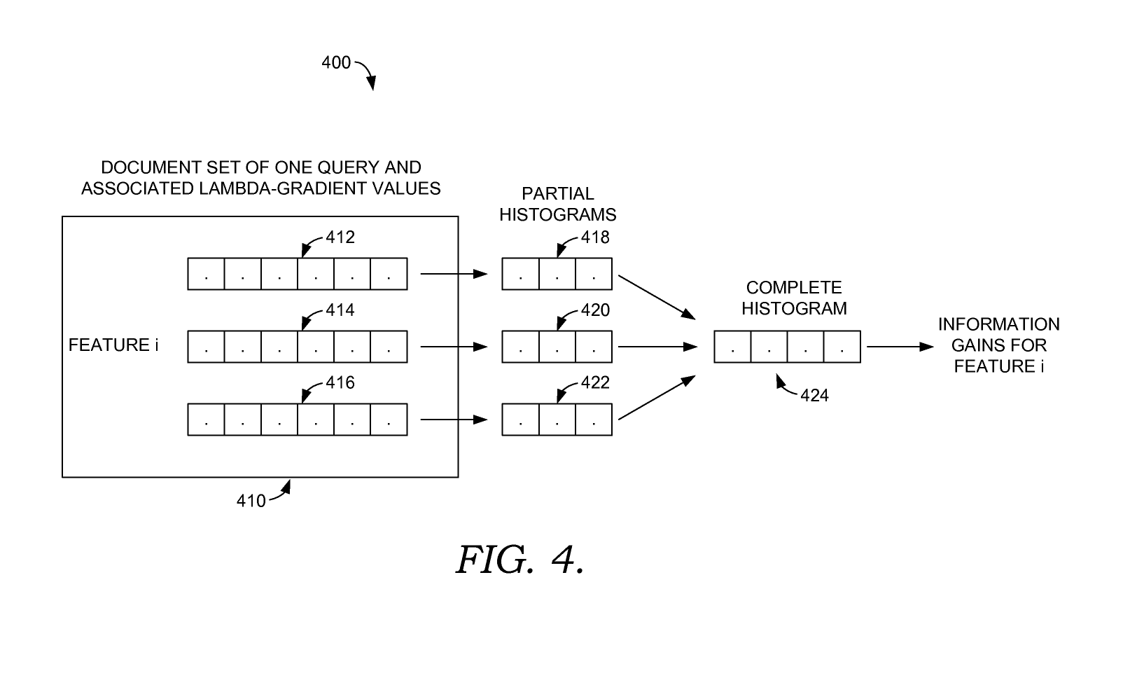

FIG. 4, referenced generally by the numeral 400, depicts the process of constructing a complete histogram from partial histograms. A document set associated with one search query is shown in box 410. The documents in box 410 are characterized by a feature, i, as determined by, for example, the regression tree component 226 of FIG. 2. The set of documents in box 410 are arranged by rows 412, 414, and 416. Each row of documents is processed by a thread block of, for example, the mapping component 230 of FIG. 2, to generate partial histograms 418, 420, and 422. The partial histograms 418, 420, and 422 are merged by, for example, the merging component 236 of FIG. 2 into a complete histogram 424, and information gains for the feature, i, are calculated by, for example, the mapping component 230 of FIG. 2.

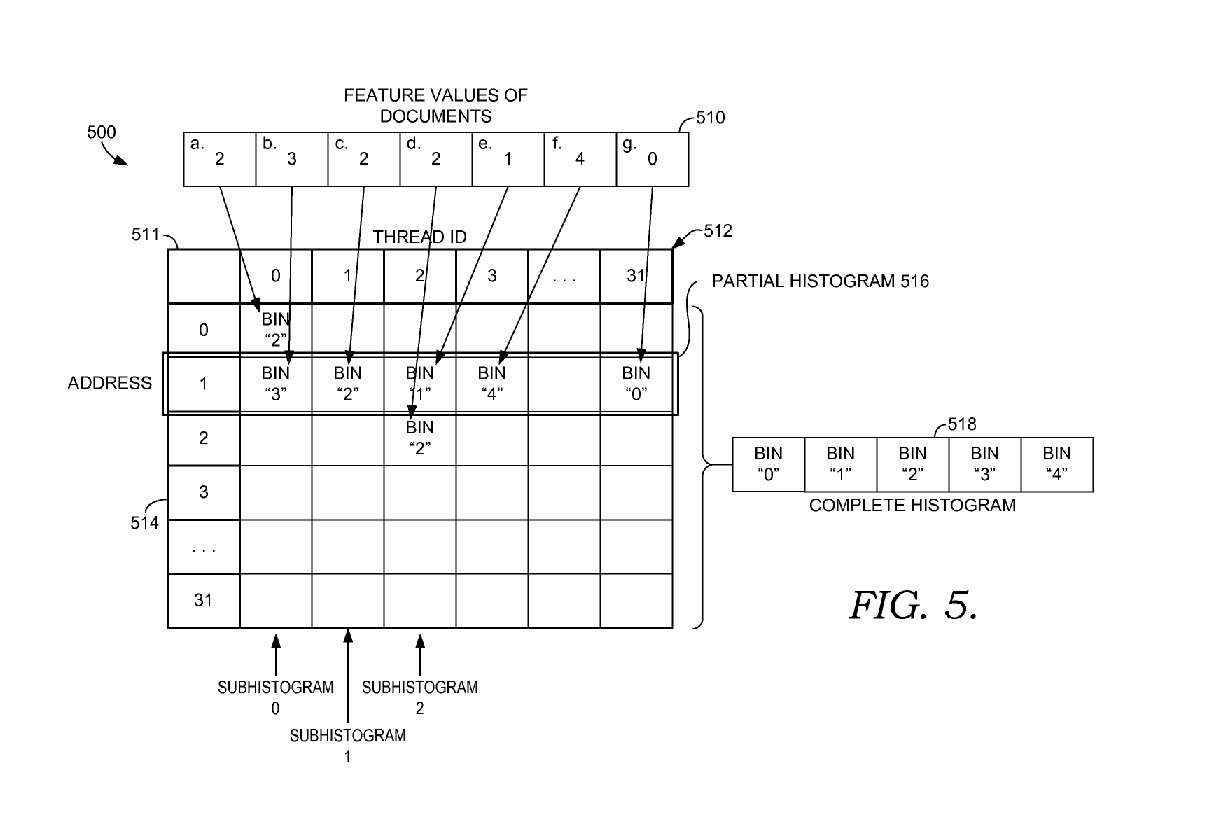

Turning now to FIG. 5, an exemplary diagram is depicted illustrating a process used by, for example, the mapping component 230 of FIG. 2 for constructing a complete histogram from partial histograms; the process is referenced generally by the numeral 500. The process 500 is used to overcome confliction problems associated with traditional parallel histogram construction on GPUs. With traditional histogram construction, each thread fetches input data associated with a document, including a feature value associated with the document, from localized shared memory, and then adds the input data to a histogram bin that collects documents having that feature value. The histogram bins can be stored in localized shared memory or memory associated with the GPU (global memory). Since all the threads fetch data and add numbers to bins simultaneously, when two or more threads try to add to the same bin, the additions must be serialized or the results will be unpredictable. The GPU solves this problem by performing atomic addition. Atomic addition occurs when a multiprocessor of the GPU ensures that each core will fetch input data associated with a document, including a feature value associated with a document, and add the data to a histogram bin at different times. For example, processor 1 would fetch a document with a feature value of “1” and add it to a histogram bin collecting documents with a feature value of “1,” and then processor 2 would fetch another document with a feature value of “1” and add it to the same histogram bin. This solves the confliction problem by serializing the additions but significantly wastes the massive parallel computing power of the GPU.

The process 500 solves the confliction problem outlined above by utilizing the localized shared memory of the GPU and partially breaking the order of input data during histogram construction within each thread. FIG. 5 depicts a row of documents 510 with each document having an associated feature value as well as an associated lambda-gradient value. Box 511 depicts a group of threads operating in parallel; each thread is identified by a thread ID 512. Further, each thread has multiple addresses 514 corresponding to bins that are used to collect feature values associated with the documents 510. Each thread builds a subhistogram for a limited number of feature values. For example, Thread ID 0 builds subhistogram 0, while Thread ID 1 builds subhistogram 1. The subhistograms are built and stored in localized shared memory, such as, for example, localized shared memory 234 of FIG. 2. This provides good locality of reference and helps to optimize performance of the GPU.

The address of the bins 414 in each subhistogram that collect the same feature value will have a different mapping amongst the different threads. Using FIG. 5 as a guide, document “a” has a feature value of 2. This document is mapped to a bin in Subhistogram 0 at address 0. Document “c” also has a feature value of 2. However, this document is mapped to a bin in Subhistogram 1 at address 1. In addition, document “d” has a feature value of 2; it is mapped to Subhistogram 2 at address 2. This differs from traditional histogram construction where documents having the same feature value would be mapped to the same address amongst the different threads (e.g., all documents having the feature value of 2 would be mapped to, for example, address 2 amongst the different threads). By shifting the bin addresses collecting the same feature value, conflicts are avoided when the partial histograms are merged to form a complete histogram.

Once all the subhistograms have been constructed by the different threads, multiple partial histograms are created. Again using FIG. 5 as an example, a partial histogram 516 is shown. The partial histogram 516 corresponds to one row of block 511. An important thing to note is that each bin that makes up the partial histogram 516 collects a different feature value. In other words, the partial histogram 516 is made up of bins having the same address 414, but each bin collects a different feature value.

A complete histogram 518 is constructed by merging the partial histograms. The merging may be accomplished, for example, by the merging component 236 of FIG. 2. The complete histogram 518 is not fully constructed until all the partial histograms have been merged. Each bin of the partial histogram 516 contains a different feature value, and each feature value is mapped to a different bin of the complete histogram 518. This effectively avoids any addition conflicts because no two bins in the partial histogram 516 contain the same feature value and, thus, will not both map to the same bin of the complete histogram 518.

Once the complete histogram 518 is fully constructed, each bin of the complete histogram 518 will contain documents having a certain feature value. The documents also have associated data including lambda-gradient values. The lambda-gradient values of a bin are accumulated (i.e., summed) and are used by, for example, the regression tree component 226 of FIG. 2 for determining an optimal threshold for splitting the documents in a parent node into two child nodes. As mentioned above, a split is optimal when it produces the highest cumulative lambda-gradient values in both child nodes for the defined feature.

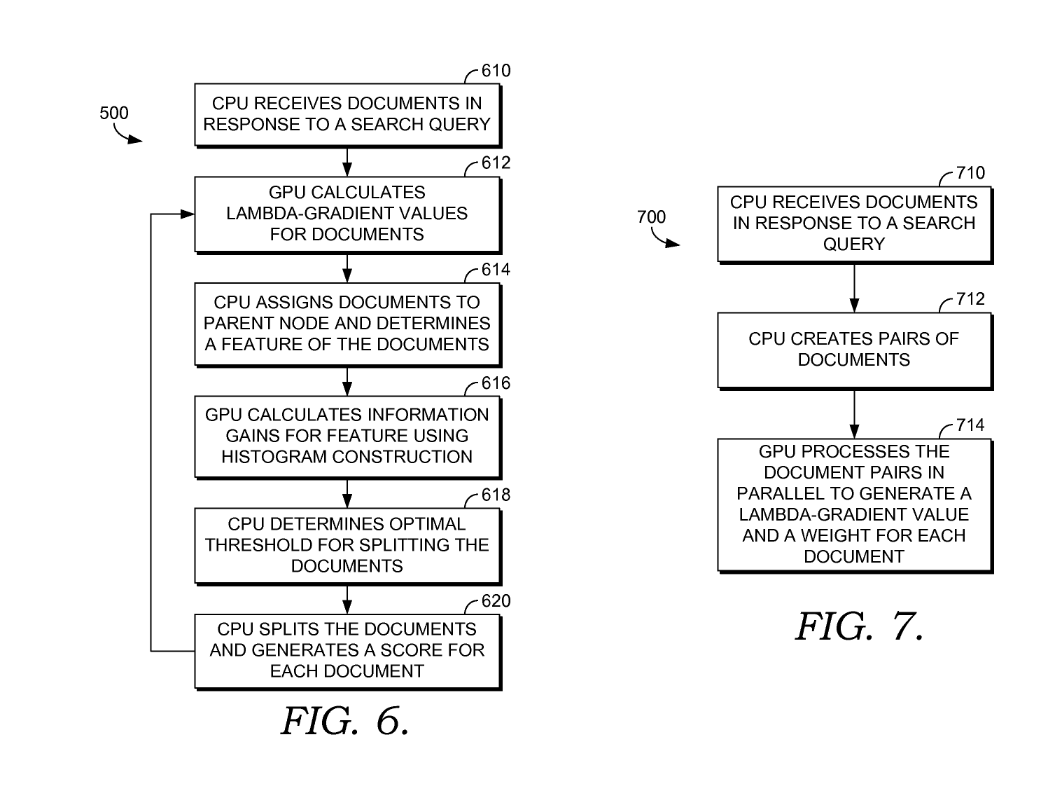

Turning now to FIG. 6, a flow diagram is depicted illustrating a method 600 for accelerating a learning-to-rank algorithm by using a central processing unit (CPU) and a graphics processing unit (GPU). At a step 610, the CPU receives a set of documents in response to a search query. In one embodiment, the documents may be received from a search engine in response to a search query, while in another embodiment, the set of documents may be received from the GPU. The documents have associated labels (applied by humans) that indicate a quality of a relationship of a document to a search query. As well, the documents may also have associated scores. The CPU creates documents pairs by pairing a first document with one or more second documents; the first document has a different label than the one or more second documents. The document pairs may be created, for example, by the pairing component 224 of FIG. 2.

At a step 612, the GPU receives the document pairs along with their associated labels and scores and calculates a lambda-gradient value and a weight for each document. The GPU processes the document pairs in parallel which helps to accelerate this portion of the learning-to-rank algorithm. The processing may be done by, for example, the processing component 232 of FIG. 2. The lambda-gradient value is a temporary value that is useable by the GPU when constructing a histogram. The weight of the document is the derivative of the lambda-gradient value.

At a step 614, the CPU receives the documents with their associated lambda-gradient values and weights and assigns the documents to a parent node. This may be done, for example, by the regression tree component 226 of FIG. 2. The CPU also determines a feature that characterizes all of the documents in the parent node. A document may have multiple features, and each features comprises a set of feature values.

At a step 616, the GPU calculates information gains for the feature using histogram construction. A complete histogram is constructed by merging a set of partial histograms. In turn, the partial histograms are constructed by mapping documents with feature values to different threads that are operating in parallel. Each thread constructs a subhistogram, and each thread has multiple addresses corresponding to bins that collect documents having a certain feature value. The address of a bin that collects the same feature value is different amongst the different threads.

Continuing with step 616, once all the subhistograms have been constructed by the different threads, the partial histograms are merged into a complete histogram. Because documents having the same feature value are mapped to bins having different addresses amongst the subhistograms, confliction problems are avoided when the partial histograms are merged into the complete histogram. In one embodiment of the invention, the partial histograms are stored and built in the localized shared memory of the GPU. If the number of partial histograms exceeds the storage capacity of the localized shared memory, however, the partial histograms may be stored in the CPU memory. When the partial histograms are stored in the localized shared memory of the GPU, the GPU merges the partial histograms into a complete histogram using, for example, the merging component 236 of FIG. 2. In another embodiment of the invention, when the partial histograms are stored in the CPU memory, the CPU merges the partial histograms into a complete histogram. After the complete histogram has been constructed, the GPU calculates information gains for the feature.

At a step 618, the CPU determines an optimal threshold for splitting the documents in the parent node into a left child node and a right child node. This may be done by, for example, the regression tree component 226 of FIG. 2. The optimal threshold is based on the information gains for the feature and comprises the highest cumulative lambda-gradient value for documents in the left child node and the highest cumulative lambda-gradient value for the documents in the right child node. Once the optimal threshold is determined, at a step 620, the CPU splits the documents into the left child node and the right child node and generates a score for each document. The score of a document determines a ranking order for the document on a search engine results page.

After the documents have been split into a left child node and a right child node and a score generated for each document, the method starts over again at step 612. The iterative method continues until the regression tree is fully built. In one embodiment of the invention, the regression tree is complete when a limit is reached requiring that a certain number of documents be present in a node. In another embodiment of the invention, the regression tree is complete when no more information gains can be made.

Turning now to FIG. 7, a flow diagram is depicted illustrating a method 700 of using a CPU and a GPU for generating lambda-gradient values for a set of documents. At a step 710, the CPU receives a set of documents returned in response to a search query. The set of documents comprise a training data set useable by a learning-to-rank algorithm to generate a ranking model for a search engine. The ranking model, in turn, is used by the search engine to assign scores to documents associated with a search query—the higher the score, the more relevant the document is. In one embodiment, the set of documents that comprise the training data set is limited to 100-150 documents.

At a step 712, the CPU creates pairs of documents. This is done by pairing a first document with one or more second documents. Each document has an associated label and an associated score. A label is a human-applied label that gives an indication of how relevant the document is to the search query. Each document in the document pair has a different label.

At a step 714, the GPU receives the pairs of documents along with their associated labels and scores and processes the document pairs in parallel to generate a lambda-gradient value and a weight for each document in the document pair. In one embodiment, each thread of the GPU processes at least one pair of documents to generate a lambda-gradient value and a weight for each document in the pair of documents.

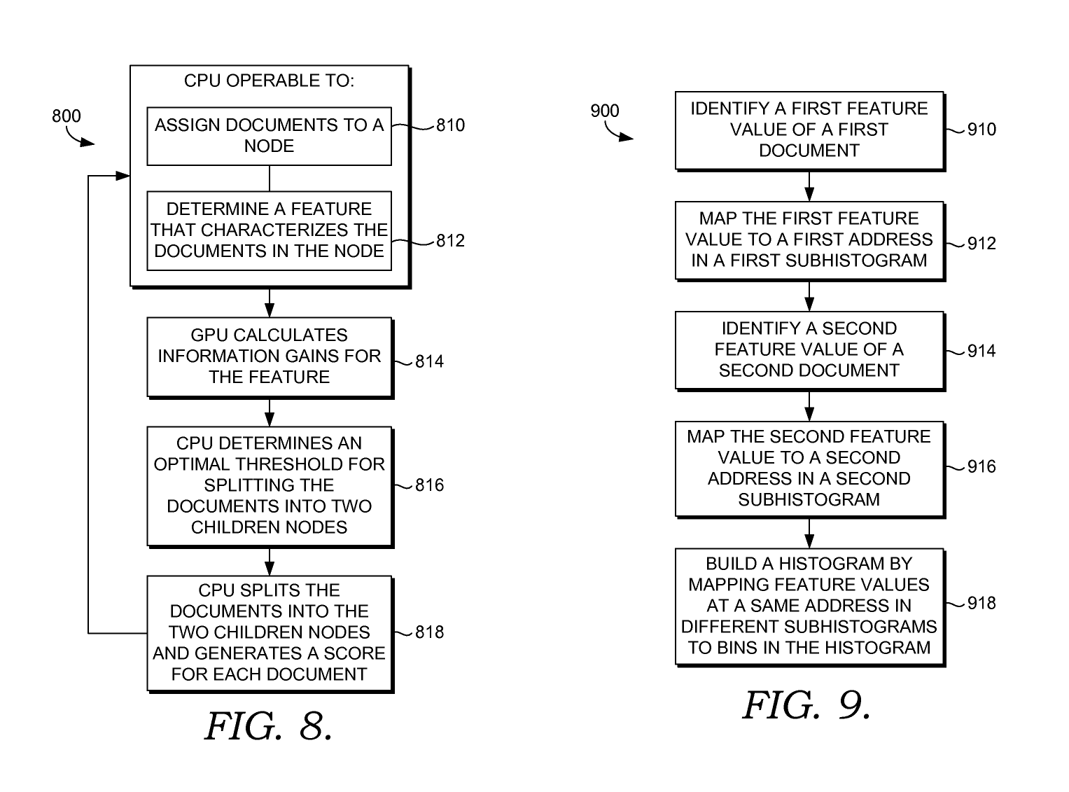

Turning to FIG. 8, a flow diagram is depicted illustrating a method 800 of using a CPU and a GPU for building a regression tree in a learning-to-rank algorithm. At a step 810, the CPU assigns a set of documents to a node. Each document in the set has an associated lambda-gradient value. At a step 812, the CPU determines a feature that characterizes all the documents in the node. A document may have multiple features, and each feature is associated with a set of feature values.

At a step 814, the GPU calculates information gains for the feature using histogram construction, and at a step 816, the CPU determines an optimal threshold for splitting the documents into two nodes. At a step 818, the CPU splits the documents into the new nodes based on the optimal threshold and generates a score for each document. The method then repeats itself for each of the nodes using a new feature until the regression tree is built. In one embodiment of the invention, the regression tree is built when a pre-defined limit is reached requiring that a certain number of documents be present in a node. In another embodiment, the regression tree is built when no more information gains are possible.

Turning now to FIG. 9, a flow diagram is depicted illustrating a method 900 of constructing a complete histogram from partial histograms using a GPU. As outlined above, the complete histogram is used to calculate information gains for a feature. The information gains, in turn, are used to determine an optimal threshold for splitting documents in a regression tree.

At a step 910, the GPU identifies a first feature value of a first document in a set of documents. The documents may be part of a training data set used by a learning-to-rank algorithm to generate a ranking model. Further, the set of documents are characterized by a feature comprising a set of feature values. The set of documents are also associated with additional data, including lambda-gradient values, labels, and scores.

At a step 912, the first feature value is mapped to a first thread building a subhistogram. The first feature value is collected in a bin at a first address of the thread. At a step 914, a second feature value of a new document is identified; the second feature value is the same as the first feature value. At a step 916, the second feature value is mapped to a bin at a second address of a second thread building another subhistogram. The second address is different than the first address.

At a step 918, a complete histogram is constructed by mapping feature values collected in bins having the same address in different threads (i.e., a partial histogram) to bins in the complete histogram. Each bin at the same address collects different feature values. As well, each feature value is mapped to a different bin in the complete histogram. This method of shifting the address of bins collecting the same feature value in different threads effectively reduces addition confliction problems when a partial histogram is mapped to the complete histogram.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. A computer-implemented system for accelerating a learning-to-rank algorithm using a central processing unit (CPU) and a graphics processing unit (GPU), the system comprising:
the CPU operable to:
(A) create two or more pairs of documents, wherein creating a pair of documents comprises pairing a first document of a set of documents with one or more second documents of the set of documents, each document of the set of documents having an associated label and an associated score, the first document having a different label than the one or more second documents;
the GPU operable to:
(A) receive the two or more pairs of documents and the associated labels and scores; and
(B) process the two or more pairs of documents in parallel to generate an output, the output comprising a lambda-gradient value and a weight for each document in the two or more pairs of documents.

2. The system of claim 1, wherein the set of documents comprises content received in response to a search query.

3. The system of claim 2, wherein a label of a document comprises a human-applied label that indicates a quality of a relationship of the document to the search query.

4. The system of claim 2, wherein the set of documents received in response to the search query includes 100 to 150 documents.

5. The system of claim 1, wherein a score of a document determines a ranking order for the document on a search engine result page.

6. The system of claim 1, wherein a lambda-gradient value of a document is a temporary value useable by the GPU when constructing a histogram.

7. The system of claim 1, wherein a weight of a document is the derivative of the lambda-gradient value for the document.

8. The system of claim 1, wherein the GPU comprises different threads of execution running in parallel, each thread of execution processing at least one pair of documents to generate a lambda-gradient value and a weight for each document in the pair of documents.

9. The system of claim 8, further comprising:
the CPU operable to:
(A) receive the two or more pairs of documents and the associated lambda-gradient values;
(B) assign the two or more pairs of documents to a parent node;
(C) determine a feature that characterizes the two or more pairs of documents in the parent node, the feature comprising a set of feature values;
incident to the CPU determining the feature that characterizes the two or more pairs of documents in the parent node, the GPU operable to:
(A) calculate information gains for the feature using histogram construction;
incident to the GPU calculating information gains for the feature, the CPU operable to:
(A) determine an optimal threshold for splitting the two or more pairs of documents in the parent node into a left child node and a right child node, the optimal threshold based on the information gains for the feature and the optimal threshold comprising the highest cumulative lambda-gradient value for documents in the left child node and the highest cumulative lambda gradient value for documents in the right child node;
(B) split the two or more pairs of documents in the parent node into a left child node and a right child node based on the optimal threshold; and
(C) generate a score for each document in the two or more pairs of documents.

10. The system of claim 9, wherein each thread of execution builds a subhistogram and each thread of execution has multiple addresses corresponding bins useable for collecting feature values of the set of documents, the address of a bin that collects the same feature value in each subhistogram being different amongst the different threads of execution.

11. The system of claim 10, further comprising:
the GPU operable to build a complete histogram by:
(A) identifying a first feature value of a first document in the parent node;
(B) mapping the first feature value to a first thread of execution building a first subhistogram, the first feature value collected in a first bin at a first address;
(C) identifying a second feature value of a second document in the parent node, the second feature value being the same as the first feature value, the second document being different from the first document;
(D) mapping the second feature value to a second thread of execution building a second subhistogram, the second feature value collected in a second bin at a second address in the second thread of execution, the second address being different from the first address; and
(E) building the complete histogram by mapping feature values collected in bins having the same address in different threads of execution to bins in the complete histogram, each feature value being different, each feature value being mapped to a different bin of the complete histogram.

12. A computer-implemented system for parallelizing regression tree building in a learning-to-rank algorithm using a central processing unit (CPU) and a graphics processing unit (GPU), the system comprising:
the CPU operable to:
(A) assign a set of documents returned in response to a search query to a parent node, each document in the set of documents having an associated lambda-gradient value;
(B) determine a first feature that characterizes the set of documents in the parent node, wherein the first feature comprises a set of feature values;
incident to the CPU determining the first feature that characterizes the set of documents in the parent node, the GPU operable to:
(A) calculate information gains for the first feature using histogram construction;
incident to the GPU calculating information gains for the first feature, the CPU operable to:
(A) determine an optimal threshold for splitting the set of documents in the parent node into a left child node and a right child node, the optimal threshold based on the information gains for the first feature and the optimal threshold comprising the highest cumulative lambda-gradient value for documents in the left child node and the highest cumulative lambda-gradient value for documents in the right child node;
(B) splitting the set of documents in the parent node into a left child node and a right child node based on the optimal threshold; and
(C) generate a score for each document in the set of documents.

13. The system of claim 12, wherein each document in the set of documents is characterized by many features.

14. The system of claim 12, further comprising:
the CPU operable to:
(A) determine a second feature that characterizes the documents in the left child node, the second feature being different from the first feature, wherein the second feature comprises a set of feature values;
incident to the CPU determining the second feature that characterizes the documents in the left child node, the GPU operable to:
(A) calculate information gains for the second feature using histogram construction;
incident to the GPU calculating information gains for the second feature, the CPU operable to:
(A) determine an optimal threshold for splitting the documents in the left child node into a left sub-child node and a right sub-child node, the optimal threshold based on the information gains for the second feature and the optimal threshold comprising the highest cumulative lambda-gradient value for documents in the left sub-child node and the highest cumulative lambda-gradient value for documents in the right sub-child node;
(B) split the documents in the left child node into the left sub-child node and the right sub-child node based on the optimal threshold; and
(C) generate a score for each document in the left sub-child node and the right sub-child node.

15. The system of claim 12, wherein documents in a node are no longer split when a limit is reached requiring that a certain number of documents be present in the node.

16. The system of claim 12, wherein an output of the regression tree is one or more scores associated with one or more documents in the set of documents, the scores useable by the GPU to generate lambda-gradient values for the one or more documents in the set of documents.

17. One or more computer storage media, executable by a computing device, for facilitating a method of a graphics processing unit (GPU) building a complete histogram using partial histograms, the GPU having different threads of execution running in parallel, each thread of execution building a subhistogram and each thread of execution having multiple addresses corresponding to bins useable for collecting feature values associated with a set of documents, the address of a bin that collects the same feature value in each subhistogram being different amongst the different threads of execution, the method comprising:
identifying a first feature value of a first document of the set of documents;
mapping the first feature value to a first thread of execution building a first subhistogram, the first feature value collected in a first bin at a first address;
identifying a second feature value of a second document of the set of documents, the second feature value being the same as the first feature value, the second document being different from the first document;
mapping the second feature value to a second thread of execution building a second subhistogram, the second feature value collected in a second bin at a second address in the second thread of execution, the second address being different than the first address; and
building the complete histogram by mapping feature values collected in bins with the same address in different threads of execution to bins in the complete histogram, each feature value being different, each feature value being mapped to a different bin of the complete histogram.

18. The media of claim 17, wherein the partial histograms are stored in localized shared memory.

19. The media of claim 17, wherein a limited number of feature values are mapped to any one thread of execution.

20. The media of claim 17, wherein each bin of the complete histogram contains lambda-gradient values associated with documents in the set of documents having the feature value collected in that bin.
